(19) United States
(12) Patent Application Publication
(10) Pub. No.: US 2017/0220959 A1
(43) Pub. Date: Aug. 3, 2017

(54) MANAGING LATENT INVENTORY OF A BUSINESS

(71) Applicant: Bacchus Fund LLC, Torrance, CA (US)

(72) Inventors: Sean Regan, Rancho Palos Verdes, CA (US); Andrew Thomas, San Francisco, CA (US)

(21) Appl. No.: 15/456,401

(22) Filed: Mar. 10, 2017

Related U.S. Application Data
(63) Continuation of application No. 15/040,696, filed on Feb. 10, 2016, now abandoned.
(60) Provisional application No. 62/288,424, filed on Jan. 28, 2016.

(51) Int. Cl. G06Q 10/02; G06Q 10/10; G06Q 10/08; G06Q 10/06

(52) U.S. Cl. CPC G06Q 10/02; G06Q 10/06398; G06Q 10/063114; G06Q 10/1095; G06Q 10/087

(57) ABSTRACT

The disclosure includes a method for booking latent inventory of a business, such as a spa business. Some methods can include determining, via a processing system, that a first unit of latent inventory is available at a first spa business. Methods can also include receiving, via the processing system, a first booking request from a customer to book the first unit of latent inventory. Some methods can include booking, via the processing system, the first unit of latent inventory with the first spa business. In some embodiments, the determining step is performed on a calendar day, and wherein the first unit of latent inventory is available on the calendar day. In response to booking the first unit of latent inventory a massage table can become available to use.

### CROSS-REFERENCE TO RELATED APPLICATIONS

This application claims the benefit of and is a continuation-in-part of U.S. Non-Provisional patent application Ser. No. 15/040,696; filed Feb. 10, 2016; and entitled MANAGING LATENT INVENTORY OF A BUSINESS; the entire contents of which are incorporated herein by reference. U.S. Non-Provisional patent application Ser. No. 15/040,696 claims the benefit and priority of U.S. Provisional Patent Application No. 62/288,424; filed Jan. 28, 2016; and entitled MANAGING LATENT INVENTORY OF A SERVICE BUSINESS; the entire contents of which are incorporated herein by reference.

### BACKGROUND

Field

The invention is generally directed to managing inventory, and more specifically, to systems and methods for managing latent inventory of a spa business.

Description of Related Art

Massage therapy often involves the rubbing and kneading of muscles and joints to relieve tension and/or pain. Typically, most consumers book a massage appointment multiple days in advance of the actual massage appointment. However, studies have shown that 60% of consumers want a massage on the same day. Unfortunately, only 13% of massage appointments are booked on the same day. Accordingly, there is a need for systems and methods to allow more consumers to book massages on the same day.

### SUMMARY

The present disclosure includes methods for booking latent inventory of a spa business. Methods can include determining, via a processing system, that a first unit of latent inventory is available at a first spa business; receiving, via the processing system, a first booking request from a computing device operated by a customer to book the first unit of latent inventory; and booking, via the processing system, the first unit of latent inventory with the first spa business, wherein the determining step is performed on a calendar day, and wherein the first unit of latent inventory is available on the calendar day. In response to booking the first unit of latent inventory, methods can also include determining, via the processing system, a location of a computing device operated by the first spa business, a location of the computing device operated by the customer, and a meeting location indicating a location of where the first spa business will meet the customer to provide therapy; and displaying, via at least one of the computing device operated by the customer and the computing device operated by the first spa business, the location of the computing device operated by the first spa business, the location of the computing device operated by the customer, and the meeting location. In response to booking the first unit of latent inventory a massage table becomes available to use.

In some embodiments, in response to booking the first unit of latent inventory, an interior door to a massage room is unlocked, wherein the massage table is located in the massage room; and an exterior door to a building is unlocked, wherein the massage room is located in the building.

Methods can include displaying, via a computing device operated by the customer, an indication of availability of the first unit of latent inventory at the first spa business. Methods can also include receiving, via the processing system, a first confirmation from the first spa business that the first unit of latent inventory has been booked for the customer.

Some methods can include determining, via the processing system, that a second unit of latent inventory is available at a second spa business. In some embodiments, the second unit of latent inventory is available on the calendar day.

Even still, methods can include determining, via the processing system, that a third unit of latent inventory is available at the first spa business. In some embodiments, the third unit of latent inventory is available on the calendar day. Methods can include determining, via the processing system, that a fourth unit of latent inventory is available at the second spa business. In some embodiments, the fourth unit of latent inventory is be available on the calendar day. Methods can include displaying, via the computing device operated by the customer, an indication of availability of at least two of the first unit of latent inventory, second unit of latent inventory, third unit of latent inventory, and fourth unit of latent inventory. Methods can also include displaying, via the computing device operated by the customer, a profile of at least one of the first spa business and the second spa business.

In response to receiving, via the processing system, the first booking request from the customer to book the first unit of latent inventory, methods can include displaying, via the computing device operated by the customer, an indication of availability of a first therapist affiliated with the first spa business and a second therapist affiliated with the first spa business to thereby provide the customer an option to select one of the first therapist and the second therapist. Methods can also include receiving, via the processing system, a second booking request from the customer to book one of the first therapist and the second therapist.

Even still, in response to receiving, via the processing system, the second booking request from the customer to book one of the first therapist and the second therapist, methods can include displaying, via a computing device operated by at least one of the first therapist and the second therapist, an indication that the customer has booked at least one of the first therapist and the second therapist. Methods can also include receiving, via the processing system, a first confirmation from the computing device operated by at least one of the first therapist and the second therapist, wherein the first confirmation comprises one of an acceptance that one of the first therapist and the second therapist has accepted the second booking request and a rejection that one of the first therapist and the second therapist has rejected the second booking request.

In response to receiving, via the processing system, the acceptance from the computing device operated by at least one of the first therapist and the second therapist, methods can include displaying, via the computing device operated by the customer, an indication of the acceptance. In response to receiving, via the processing system, the rejection from the computing device operated by at least one of the first therapist and the second therapist, methods can include displaying, via the computing device operated by the customer, an indication of the rejection.

Even still, in response to displaying, via the computing device operated by the customer, an indication of the rejection, methods can include displaying, via the computing device operated by the customer, an indication of availability of a third therapist affiliated with the first spa business and a fourth therapist affiliated with the first spa business to thereby provide the customer an option to select one of the third therapist and the fourth therapist; displaying, via the computing device operated by the customer, an indication of availability of the second unit of latent inventory, third unit of latent inventory, and fourth unit of latent inventory; receiving, via the processing system, an indication that the customer has rejected the indication of availability of the second unit of latent inventory, third unit of latent inventory, and fourth unit of latent inventory; in response to receiving, via the processing system, an indication that the customer has rejected the indication of availability of the second unit of latent inventory, third unit of latent inventory, and fourth unit of latent inventory: receiving, via the processing system, an indication from the computing device operated by one of the first therapist and the second therapist of when one of the first therapist and the second therapist will be available; displaying, via the computing device operated by the customer, an indication of a new proposed time when one of the first therapist and the second therapist will be available; and receiving, via the processing system, a second confirmation from the computing device operated by the customer that the customer has accepted the new proposed time when one of the first therapist and the second therapist will be available.

In some embodiments, the first spa business comprises one of a retail spa business, a massage therapist affiliated with the retail spa business, and a massage therapist unaffiliated with the retail spa business. Methods can even include determining, via the processing system, a location of the computing device operated by the customer. In some embodiments, the first spa business is determined based upon the location of the computing device operated by the customer.

In some embodiments, the first spa business comprises one of the massage therapist affiliated with the retail spa business and the massage therapist unaffiliated with the retail spa business. Methods can include determining, via the processing system, a location of a computing device operated by the first spa business; displaying, via the computing device operated by the customer, the location of the computing device operated by the first spa business; and displaying, via the computing device operated by the customer, an indication that the first spa business will arrive at a location within a time frame. In some embodiments, the location comprises at least one of a site where the customer is located and a site of a retail spa business.

Some methods can include at least one of: receiving, via the processing system, a first rating of the first spa business from the computing device operated by the customer; and receiving, via the processing system, an indication of a favorite spa business from the computing device operated by the customer. Methods can even include determining, via the processing system, a rating of the first spa business from a third party database. In some embodiments, the third party database comprises at least one of a website and a mobile application.

Methods can include receiving, via the processing system, an indication of payment from the customer for booking at least one of the first unit of latent inventory, at least a portion of a membership premium with a company affiliated with the processing system, a monetary tip for a therapist, and a product. In some embodiments, the first unit of latent inventory is available within five hours of the determining step being performed.

The disclosure also includes a method for booking latent inventory of a spa business. Methods can include receiving, via a computing device operated by the spa business, a request from a customer to book a first unit of latent inventory of the spa business; booking, via the computing device operated by the spa business, the first unit of latent inventory of the spa business; and sending, via the computing device operated by the spa business, a confirmation of the booking of the first unit of latent inventory to a third party processing system. In some embodiments, the receiving step is performed on a calendar day, and the first unit of latent inventory is available on the calendar day. In some embodiments, in response to booking the first unit of latent inventory a massage table becomes available to use.

In response to booking the first unit of latent inventory, the method can further include automatically unlocking, via an electronic door lock system, a lock located on an interior door to a massage room, wherein the massage table is located in the massage room.

Some methods can include opting in, via the computing device operated by the spa business, to a third party application for booking latent inventory of the spa business. Methods can include displaying, via a computing device operated by a therapist affiliated with the spa business, an indication that the customer has booked the first unit of latent inventory of the spa business. In some embodiments, the first unit of latent inventory is available within three hours of the receiving step being performed.

The disclosure also includes a method for booking inventory with a massage therapist. Methods can include receiving, via a computing device operated by the therapist, a request from a customer to book a first unit of latent inventory of the therapist; and sending, via the computing device operated by the therapist, a confirmation that the first unit of latent inventory of the therapist has been booked. In some embodiments, the receiving step is performed on a calendar day, and the first unit of latent inventory is available on the calendar day. In some embodiments, in response to receiving the request from the customer a massage table becomes available to use.

In response to receiving the request from the customer, the method can further include automatically unlocking, via an electronic door lock system, a lock located on an exterior door to a building, wherein the massage table is located in the building.

Methods can even include determining, via the computing device operated by the therapist, that a second unit of latent inventory of a spa business is available. In some embodiments, the second unit of latent inventory of the spa business comprises an amount of time that a vacant room is available at the spa business. Some methods include booking, via the computing device operated by the therapist, the second unit of latent inventory of the spa business.

In some embodiments, the first unit of latent inventory is available within thirty minutes of the determining step being performed. Even still, in some embodiments, the receiving step is performed in response to the therapist being located within a predetermined distance of the customer.

In some embodiments, the therapist is a first therapist, and the receiving step is further performed in response to: the customer having previously booked a unit of latent inventory with the first therapist at a time before the calendar day; the first therapist being located closer to the customer than a second therapist; the first therapist selecting, via the computing device operated by the therapist, a status as available; the first therapist having a performance rating greater than a predetermined performance rating threshold; and the first unit of latent inventory of the first therapist being available before a second unit of latent inventory of the second therapist. The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments. The above and other features of the present invention will become more apparent by describing in detail exemplary embodiments thereof with reference to the accompanying drawings, in which:

FIG. 1 illustrates a schematic of a first communication system, according to some embodiments;

FIG. 2 illustrates a schematic of a second communication system, according to some embodiments;

FIG. 3 illustrates a schematic of a third communication system, according to some embodiments;

FIG. 4 illustrates a flow chart of a method for booking latent inventory of businesses, according to some embodiments;

FIG. 5 illustrates a first calendar day, according to some embodiments;

FIG. 6 illustrates a second calendar day, according to some embodiments;

FIG. 7 illustrates a third calendar day, according to some embodiments;

FIGS. 8 and 9 illustrate flow charts of methods for booking latent inventory of businesses, according to some embodiments; and

FIGS. 10, 11, 12, 13, 14, 15, 16, and 17 illustrate flow charts of methods for booking latent inventory of businesses, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### LIST OF REFERENCE NUMERALS

10—Communication system
12—Processing system
14—Computing device
16—Communication network
18—Spa business
20a—Retail spa business
20b—Massage therapist affiliated with the retail spa business
20c—Massage therapist unaffiliated with the retail spa business
22—Unit of latent inventory
24—Calendar day
26—Massage table
28—Door lock system

### Introduction

Many businesses, such as spa businesses, have unused supply (e.g. massage rooms and therapists) that cost the businesses significant overhead costs. This unused supply can be referred to as “latent inventory.” On the demand side, many consumers are unaware that the latent inventory exists. Specifically within the spa industry, studies have shown that 60% of consumers want a massage on the same day, yet only 13% of bookings are made same day. Unfortunately, consumers and businesses suffer from the lost opportunities associated with latent inventory.

This disclosure includes communication systems and methods that allow businesses to increase visibility of latent inventory to consumers. Not only can this bridge the gap between same day supply and demand, but also can result in increased revenues and profits for businesses, as well as lower barriers to entry for smaller businesses to compete against larger companies.

While this disclosure describes an embodiment specific to the spa industry, in no way is this disclosure limited to the spa industry. Rather, the systems and methods described in this disclosure can be applied across any service industry, such as hair salons, nail salons, photography businesses, video production businesses, interior design businesses, permanent retail space for selling goods/services, temporary retail space for selling goods/services, permanent and temporary office space, medical facilities, medical staff, hospital beds, surgical rooms, doctors, doctors offices, home improvement businesses, employees of a business, and the like. More specifically, in some embodiments, the systems and methods can be focused on latent inventory in the medical industry, such as acute medical care, temporary nursing care (e.g. post-surgery care), in-home rental medical equipment, and the like. Generally, the systems and methods described herein can be used to match acute needs that when left unfulfilled, reduce the market size and create customer frustration, due to inventory opacity of a product or service.

### Communication System Embodiments

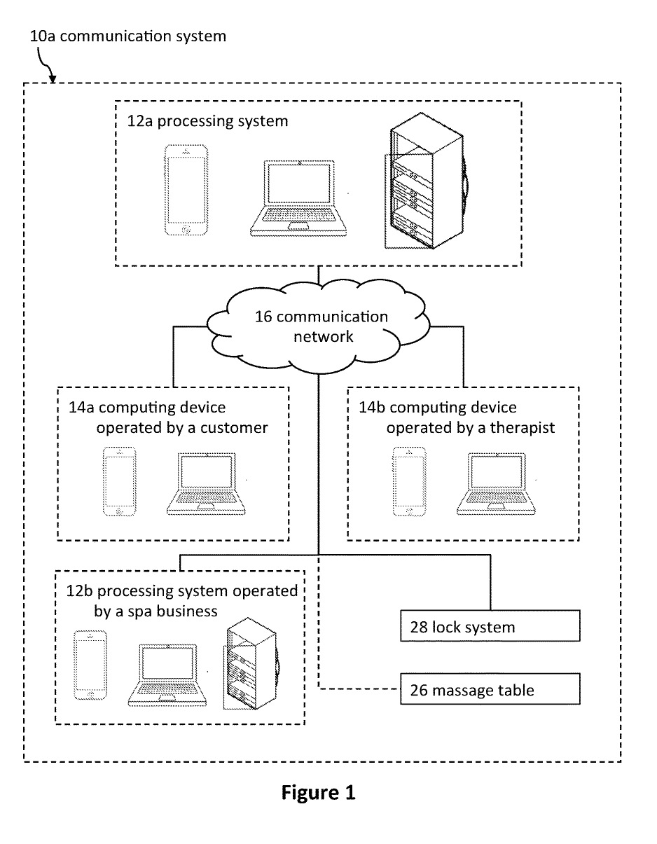

FIGS. 1-3 illustrate various communication systems 10 that can be used to implement the methods described herein. As illustrated in FIG. 1, a communication system 10a can include a processing system 12a, which can be communicatively coupled to a communication network 16, such as a cellular network, telecommunication network, and/or any type of wireless and/or wired network. Even still, in some embodiments, the communication network 16 can include a Local Area Network (LAN) and/or a Wide Area Network (WAN). It should be appreciated that the communication network 16 can include storage systems, such as cloud storage, enterprise storage, and/or networked enterprise storage that can be used to store data from any part of the communication system 10 and methods below.

The communication network 16 can also include software, such as a website and/or mobile application implemented on a computing device or processing system, that can serve as a communication platform so that any of the processing systems 12 and/or computing devices 14, as shown and described in FIGS. 1-3, can communicate with each other. It should be appreciated that the software can implement any of the methods as described throughout this disclosure.

With continued reference to FIG. 1, the processing system 12a can be communicatively coupled to a computing device 14, such as a computing device 14a operated by a customer and/or a computing device 14b operated by a therapist. As well, the processing system 12a can be communicatively coupled to additional processing systems, such as a processing system 12b operated by a spa business. The processing system 12 can include any number of computer processors, servers, and/or computing device(s) 14 communicatively coupled together. It should be appreciated that computing devices 14 can include desktop computers, laptop computers, remote computing devices, such as cellular phones, smartphones, tablets, e-readers, portable music players, and the like.

As further shown in FIG. 1, the communication system 10a can include additional devices and systems, including a massage table 26 and an electronic door lock system 28. The door lock system 28 can be communicatively coupled through the communication network 16. The door lock system 28 can be located on any type of interior or exterior door located inside or outside the spa business (e.g. building) and/or the massage room.

In many embodiments, the door lock system 28 can thereby be arranged and configured to lock and unlock in response to any method step recited in this disclosure. For example, in response to receiving a request to book a massage from a customer, methods can include automatically unlocking, via the door lock system 28, a lock located on an exterior door to a building. As well, in response to booking the first unit of latent inventory, methods can include automatically unlocking, via the door lock system 28, a lock located on an interior door to a massage room. Stated differently, in response to booking the first unit of latent inventory, an interior door to a massage room is unlocked, and an exterior door to a building is unlocked. It should be appreciated that the massage room can be located in the building and the massage table 26 can be located in the massage room.

Furthermore, the massage table 26 can be configured to become available or unavailable in response to any of the method steps recited in this disclosure. For example, in response to receiving a request from a customer the massage table 26 can become available to use by the massage therapist and/or customer. In some embodiments, in response to booking a first unit of latent inventory the massage table 26 can become available to use. In some embodiments, the massage table 26 may be automatically unfolded into an open position in response to the method steps described herein. The unfolding may be performed by custom machinary or hardware that is part of the communication system 10.

Furthermore, in some embodiments, the method steps described herein can cause an indication (e.g. a sign) to be displayed on or near the massage table 26 indicating that the massage table 26 is available for use. For example, a custom sign may display an indication notifying others that the massage table 26 is available or unavailable depending on whether a unit of latent inventory was booked. In this regard, by stating that the massage table 26 has become available to use provides a real world outcome in response to the method steps performed on the systems and devices described herein.

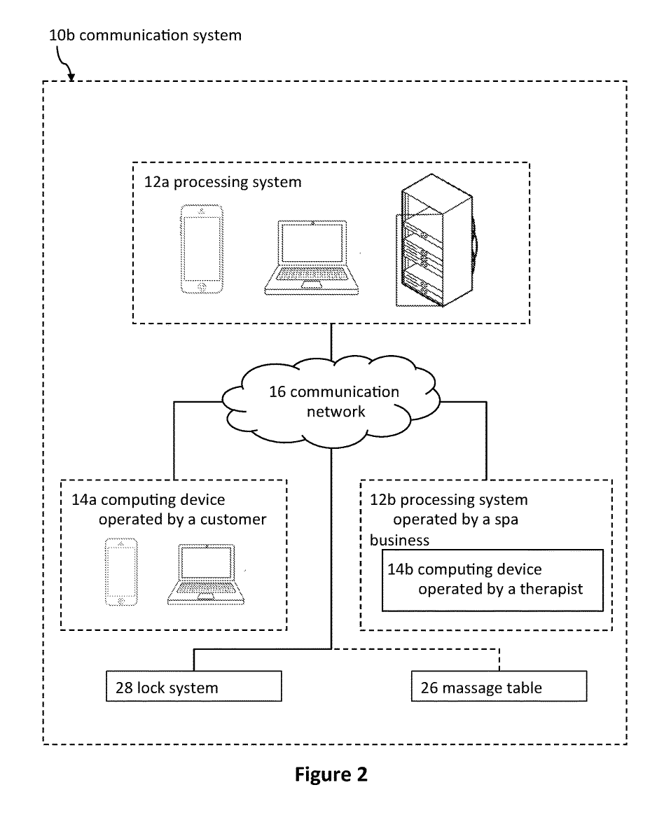

The disclosure also includes various configurations of communication systems. For example, as shown in FIG. 2, the communication system 10b can include the processing system 12a communicatively coupled to the communication network 16. The processing system 12a can be further communicatively coupled through the communication network 16 to a computing device 14a operated by a customer and a processing system 12b operated by a spa business. In some embodiments, the processing system 12b operated by the spa business can further include various computing devices, such as a computing device 14b operated by a therapist. Generally, the processing system 12b operated by the spa business can include any computing device operated by any employee, customer, and/or visitor of the spa business.

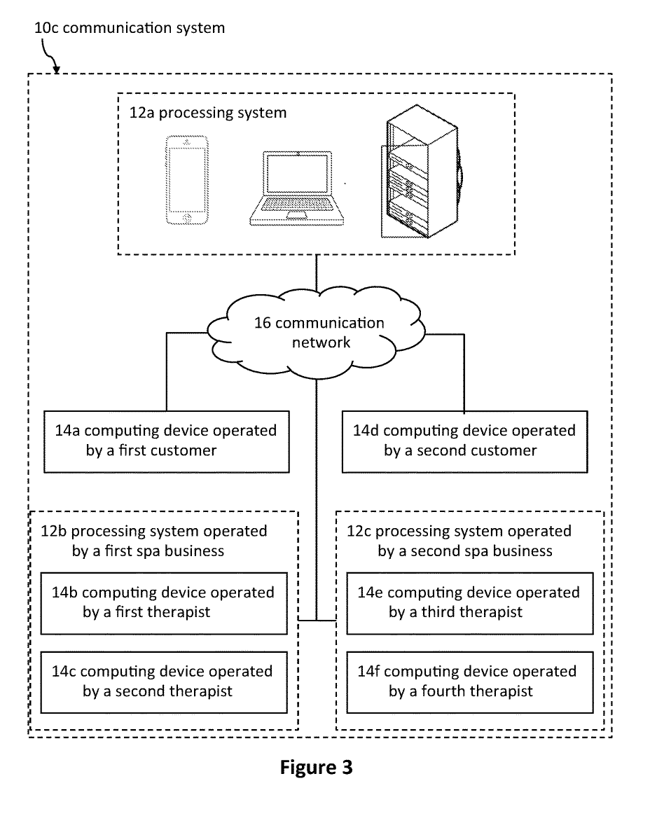

Even still, FIG. 3 illustrates another embodiment of a communication system 10c. As shown in FIG. 3, the communication system 10c can include a processing system 12a communicatively coupled to a communication network 16. As well, the communication system 10c can also include various computing devices 14 and processing systems 12 all communicatively to the processing system 12a via the communication network 16. As shown in FIG. 3, the communication system 10c can include a computing device 14a operated by a first customer and a computing device 14d operated by a second customer. The communication system 10c can include any number of computing devices 14 operated by any number of customers, therapists, employees, and the like.

With continued reference to FIG. 3, the communication system 10c can include a processing system operated by a first spa business 12b and a processing system operated by a second spa business 12c. It should be appreciated that the communication system 10c can include any number of processing systems 12 operated by any number of spa businesses. Furthermore, as shown in FIG. 3, the processing system 12b operated by the first spa business can include a computing device 14b operated by a first therapist and a computing device 14c operated by a second therapist. As well, the processing system 12c operated by the second spa business can further comprise a computing device 14e operated by a third therapist and a computing device 14f operated by a fourth therapist. Generally, the processing systems 12b, 12c can include any number of computing devices 14 operated by any number of customers, therapists, employees, guests, and the like.

In some embodiments, the processing system 12a communicates and/or receives data from the processing system 12b operated by the spa business (or any other business disclosed above) through a third party business management software, which can track transactions and resources of a business, such as sales and inventory. The third party business management software can be any variety of software packages (or combinations of software packages), such as those commonly known as MINDBODY®, Booker®, mHelpDesk®, Brightpearl®, Front Desk™, Epic.com, Farmsoft.com, and the like. Generally, it should be appreciated that the third party business management software can be any type of software that tracks inventory, sales, marketing, scheduling, and the like.

The processing system 12a can thereby implement the methods described herein through application protocol indexes (API) that can determine latent inventory of the respective spa business by communicating with the third party business management software, as described above. In this regard, the processing system 12a can retrieve the API(s), which thereby communicates and/or interacts with the third party business management software to determine and/or receive data (e.g. latent inventory) about the spa business. The processing system 12a can thereby take the data (e.g. latent inventory data), as retrieved from the respective business, and present the data in an easily readable format on the computing devices 14 of customers, therapists, and anyone else affiliated with systems and methods disclosed herein.

### Methods of Booking Latent Inventory

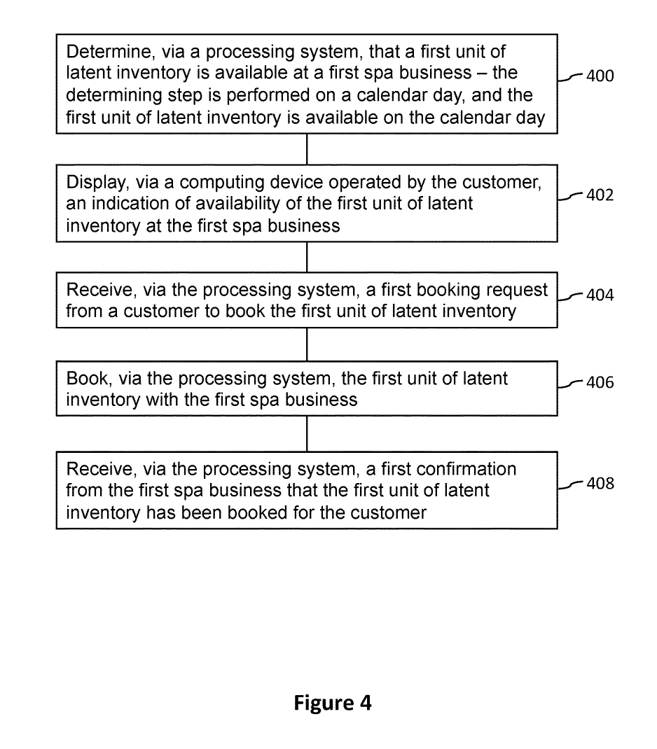

The communication systems 10 described above can implement methods further described herein. As illustrated in the flow chart in FIG. 4, methods can include determining, via a processing system 12, that a first unit of latent inventory is available at a first spa business (at step 400). In other words, software, such as a mobile application, can determine that a spa has unused inventory that is available for a customer. As well, methods can include displaying, via a computing device 14 operated by the customer, an indication of availability of the first unit of latent inventory at the first spa business (at step 402). In some embodiments, this includes displaying on a screen of a smartphone or a computer (e.g. operated by a customer) any type of notification that a unit of latent inventory is available at a spa business.

Accordingly, some methods can include receiving, via the processing system 12, a first booking request from a customer to book the first unit of latent inventory (at step 404). In some embodiments, the customer books the first unit of latent inventory via a computing device 14. In response to step 404, methods can include booking, via the processing system 12, the first unit of latent inventory with the first spa business (at step 406) on behalf of the customer. The method can further include receiving, via the processing system 12, a first confirmation from the first spa business that the first unit of latent inventory has been booked for the customer (at step 408). In some embodiments, the confirmation includes a text message, email, phone call, and the like.

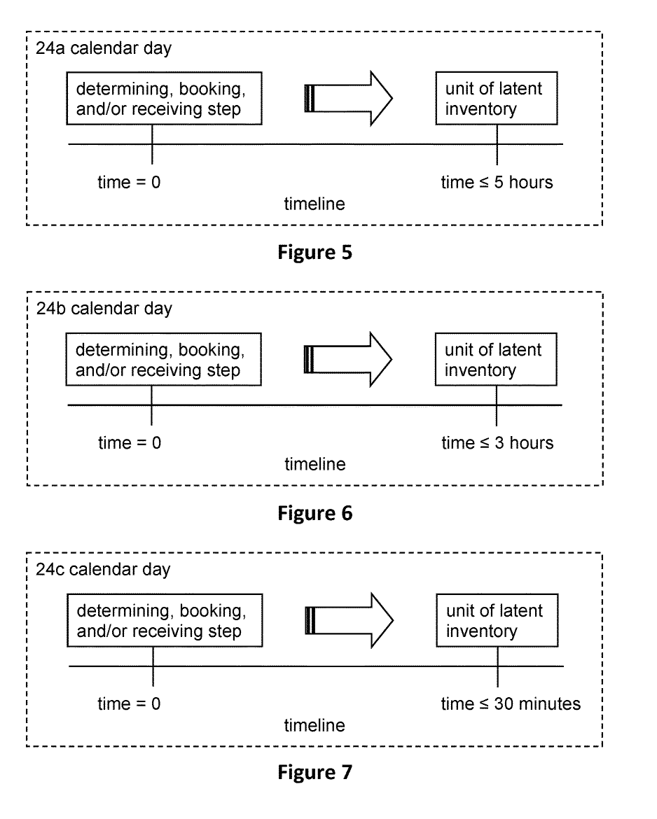

Methods described herein can be intended to satisfy real-time demand or near-real time demand (such as on the same day). In such embodiments, the unit(s) of latent inventory is available within five hours. FIGS. 5-7 further illustrate this point. As shown, any of the determining, booking, and/or receiving steps, disclosed herein, can be performed at time =0. Accordingly, the timelines shown in FIG. 5-7 show that the latent inventory can be available within various amounts of time from the occurrence of any of the determining, booking, and/or receiving steps. For example, FIG. 5 shows that a unit of latent inventory is available within 5 hours of any of the determining, booking, and/or receiving steps being performed. FIG. 6 shows that a unit of latent inventory is available within 3 hours, while FIG. 7 shows that a unit of latent inventory is available within 30 minutes. It should be appreciated that these are just a few times used for illustrative purposes. The unit of latent inventory can be available within any amount of time from the determining, booking, and/or receiving steps being performed, such as one second, one minute, ten hours, two days, two week, two months, or any amount of time therein.

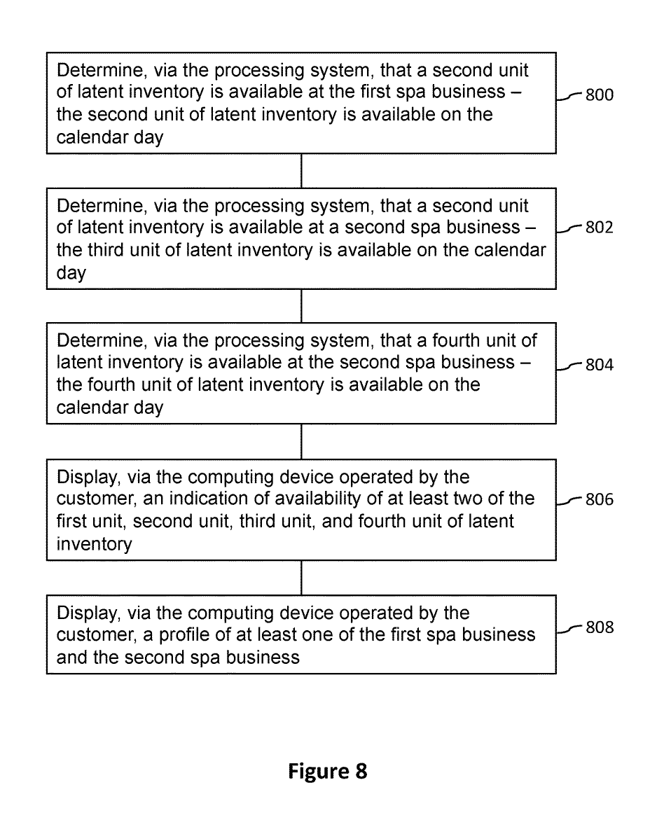

The system can also be configured to determine whether multiple units of latent inventory exist. As shown in FIG. 8, methods can include determining, via the processing system 12, that a second unit of latent inventory is available at the first spa business (at step 800). For example, if the determining step is performed at 8:00 am the method may determine that there is a first unit of latent inventory available from 9:00 am to 10:00 am and a second unit of latent inventory available from 7:00 pm to 8:30 pm on the same day. It should be appreciated that the units of latent inventory can be different amounts of time starting at various times of the day.

In some embodiments, methods can also determine whether latent inventory exists at more than one spa business. For example, FIG. 8 shows that embodiments include determining, via the processing system 12, that a third unit of latent inventory is available at a second spa business (at step 802). Even still, methods can include determining, via the processing system 12, that a fourth unit of latent inventory is available at the second spa business (at step 804). It should be appreciated that the first spa business and second spa business can be completely unaffiliated with each other (e.g. McDonald's relation to Burger King) or the first and second spa businesses can both be affiliated with the same entity, such as owned by the same entity and/or franchisees of a common entity (e.g. a first McDonald's restaurant and a second McDonald's restaurant).

Methods that include determining whether multiple units of inventory exist, can also include steps to notify the customer of the availability of the multiple units. For example, methods can include displaying, via the computing device 14 operated by the customer, an indication of availability of at least two of the first unit, second unit, third unit, and fourth unit of latent inventory (at step 806). It should be appreciated that this can include displaying any type of notification on a screen of a computing device 14.

Customers may wish to compare a first spa to a second spa before deciding at which spa to book a therapy session. Similar to how some restaurant-goers analyze Yelp® reviews for various restaurants before deciding where to book a dining reservation, customers of the systems and methods disclosed herein may wish to compare reviews and ratings of spas before booking a therapy session. Accordingly, methods of this disclosure may include steps to inform customers of reviews and/or ratings of various spas, such as the first spa business and the second spa business. For example, methods may include displaying, via the computing device 14 operated by the customer, a profile of at least one of the first spa business and the second spa business (at step 808). It should be appreciated that the profile of the respective spa business can include any review, rating, address, phone number, website, and/or bibliographic information about the respective spa business.

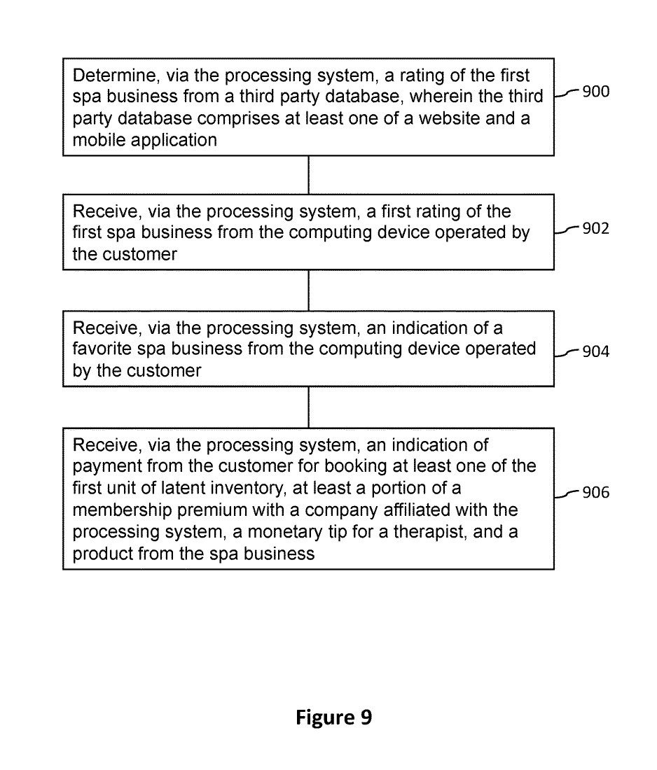

The profiles may be received from third-party databases (e.g. websites, mobile applications, consumer watchdog services, Google®, and the like) or solicited organically from customers who use the systems and methods described herein. For example, FIG. 9 shows that methods may include determining, via the processing system 12, a rating of the first spa business from a third party database (at step 900). As well, methods can include receiving, via the processing system 12, a rating and/or review of the spa business from the computing device 14 operated by the customer. This rating/review may be accumulated by the communication system 10 and then used by the system to determine an objective indicator to inform other customers of the performance of the spa business and the customer's satisfaction level. For example, the rating/review may be compiled towards a cumulative rating of a spa business. Accordingly, the cumulative rating can comprise an average of a first rating of the spa business (from a first customer) and a second rating of the spa business (from a second customer).

Even still, some customers may have “favorite” spas, which they repeatedly and/or frequently visit. Accordingly, the disclosure includes steps whereby customers can indicate that a spa is his/her favorite. For example, methods can include receiving, via the processing system 12, an indication of a favorite spa business from the computing device 14 operated by the customer (at step 904). This type of indication can be used for various searches and filters to prominently display the customer's “favorite” spa at the top of search results. This feature can enhance the method and provide value to the customer because the customer will not have to search and scroll within the results to find his/her favorite spa.

The system may also be configured to receive payment from customers for services rendered and/or products sold to the customer. For example, methods may include receiving, via the processing system 12, an indication of payment from the customer (at step 906). The payment may be tendered for booking a unit of latent inventory, at least a portion of a membership premium for access to the system or method, a monetary tip for a therapist, and/or a product from the respective spa business.

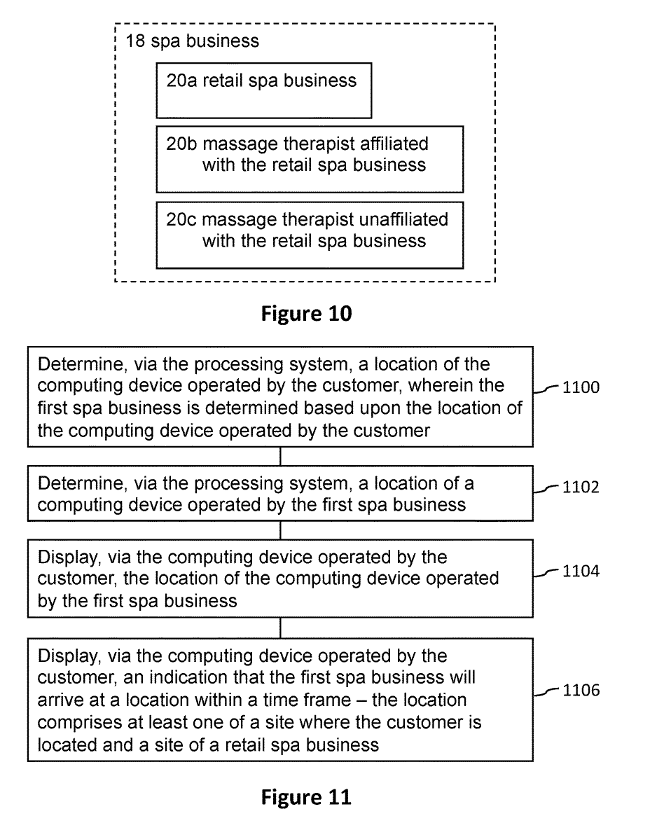

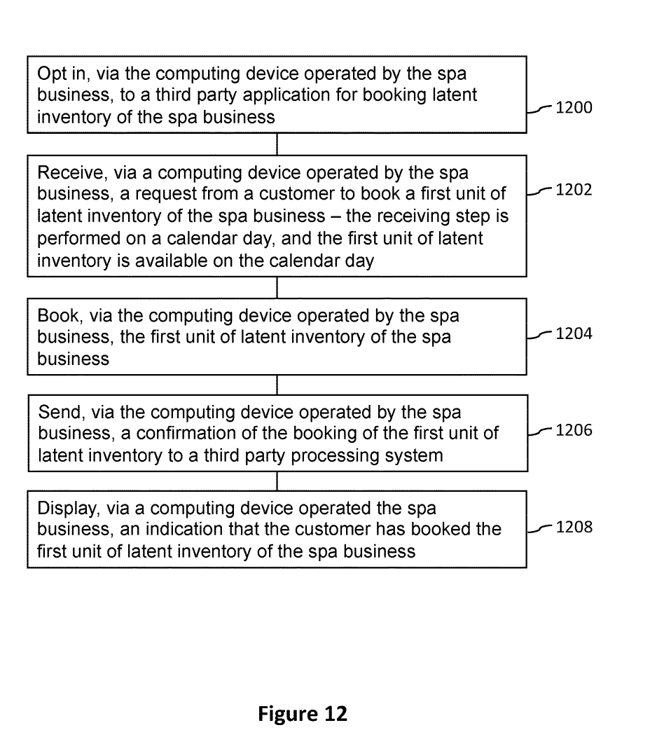

The disclosure also includes systems and methods that can determine the location of various parties and entities, such as the customer, the spa business, and the like. As shown in FIG. 10, the spa business 18 can include any various type of therapy provider, such as a brick and mortar retail spa business 20a having a fixed location. As well, the spa business 18 can include a massage therapist affiliated with the retail spa business 20b and/or a massage therapist unaffiliated with the retail spa business 20c. As such, the massage therapist 20b, 20c can be mobile and may provide therapy at the retail spa business 20a location, or other locations, such as the customer's residence or work, the massage therapist's home, or any other third party location affiliated with or unaffiliated with the customer and/or therapist. As such, the massage therapist 20b, 20c can move with respect to the customer.

For example, FIG. 11 shows that methods include determining, via the processing system 12, a location of the computing device 14 operated by the customer (at step 1100). In some methods, the spa business is determined based upon the location of the computing device 14 operated by the customer. For example, spas located closer to the customer may appear higher on search results. As well, methods may include determining, via the processing system 12, a location of a computing device 14 operated by the first spa business (at step 1102). Because the spa business may be a fixed retail location or a therapist on the move, methods may include displaying, via the computing device 14 operated by the customer, the location of the computing device 14 operated by the first spa business (at step 1104). The displaying steps can include displaying a notification on a screen of the computing device 14, whereby the notification comprises a dot on a map to indicate location. Even still, methods may include displaying, via the computing device 14 operated by the customer, an indication that the spa business (i.e. massage therapist 20b, 20c) will arrive at a location within a time frame (at step 1106). It should be appreciated that the location may comprise at least one of a site where the customer is located and a site of a retail spa business.

Accordingly, the methods may include steps to decipher the locations of the customer, therapist, spa location, and thereby coordinate meeting points. For example, methods may include displaying, via a computing device 14 operated by the customer, a first location indicating the location of the therapist. Once the customer books a session with the therapist, the method may then include displaying, via the computing device 14 operated by the customer, a second location indicating the location of the meeting point where the therapist will meet the customer to provide therapy.

Because the disclosure includes all types of therapy providers, as previously described, the systems and methods may be configured to navigate any scenario arising from interactions between such parties. To illustrate with a more real world example, therapist Jane may open a smartphone application that implements the methods described herein. Accordingly, methods may include a step of opting in, via the computing device operated by the spa business (e.g. therapist Jane), to a third party application (e.g. smartphone application) for booking latent inventory of the spa business (at step 1200). Therapist Jane may change her status (via the smartphone application) to available, meaning she is available to provide massage therapy. Customer Lisa may also open a similar smartphone application (e.g. a consumer-facing version of the application), whereby customer Lisa can see that therapist Jane is available and in the area. Stated differently, methods may include receiving, via a computing device 14 operated by the spa business (e.g. therapist Jane, massage therapist 20b, 20c), a request from a customer (e.g. customer Lisa) to book a first unit of latent inventory of the spa business (at step 1202).

Customer Lisa may book a therapy session with therapist Jane. Accordingly, therapist Jane may receive the request as detailed in step 1202. The request from customer Lisa may have been to receive the therapy session at a third-party neutral location, such as a brick and mortar spa business 20a that is affiliated or unaffiliated with therapist Jane. Accordingly, methods may include booking, via the computing device 14 operated by the spa business (e.g. therapist Jane), the first unit of latent inventory of the spa business (e.g. a massage room at a brick and mortar spa business 20a) (at step 1204).

Methods may then include the step of sending, via the computing device 14 operated by the spa business, a confirmation of the booking of the first unit of latent inventory to a third party processing system (at step 1206). In some embodiments, the third-party processing system may be a company affiliated with the software (e.g. smartphone application) used by therapist Jane and customer Lisa. Methods may also include displaying, via a computing device 14 operated by the spa business (e.g. therapist Jane), an indication that the customer (e.g. customer Lisa) has booked the first unit of latent inventory of the spa business (at step 1208).

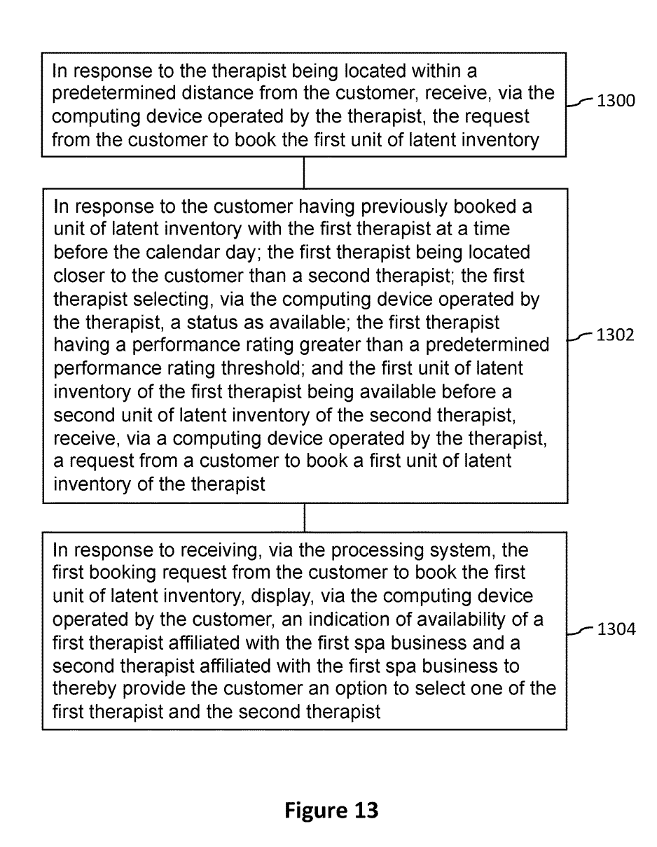

As illustrated in FIG. 13, some methods may also include detailed steps that occur in response to various other steps being performed. For, example, in response to the therapist being located within a predetermined distance from the customer, methods may include receiving, via the computing device 14 operated by the therapist, the request from the customer to book the first unit of latent inventory (at step 1300). In some embodiments, the step of receiving, via a computing device 14 operated by the therapist, a request from a customer to book a first unit of latent inventory of the therapist may occur in response to numerous other steps and/or conditions being satisfied, such as the customer having previously booked a unit of latent inventory with the first therapist at a time before the calendar day; the first therapist being located closer to the customer than a second therapist; the first therapist selecting, via the computing device operated by the therapist, a status as available; the first therapist having a performance rating greater than a predetermined performance rating threshold; and the first unit of latent inventory of the first therapist being available before a second unit of latent inventory of the second therapist (at step 1302).

Accordingly, in response to receiving, via the processing system 12, the first booking request from the customer to book the first unit of latent inventory, the method may include displaying, via the computing device 14 operated by the customer, an indication of availability of a first therapist affiliated with the first spa business and a second therapist affiliated with the first spa business to thereby provide the customer an option to select one of the first therapist and the second therapist (at step 1304).

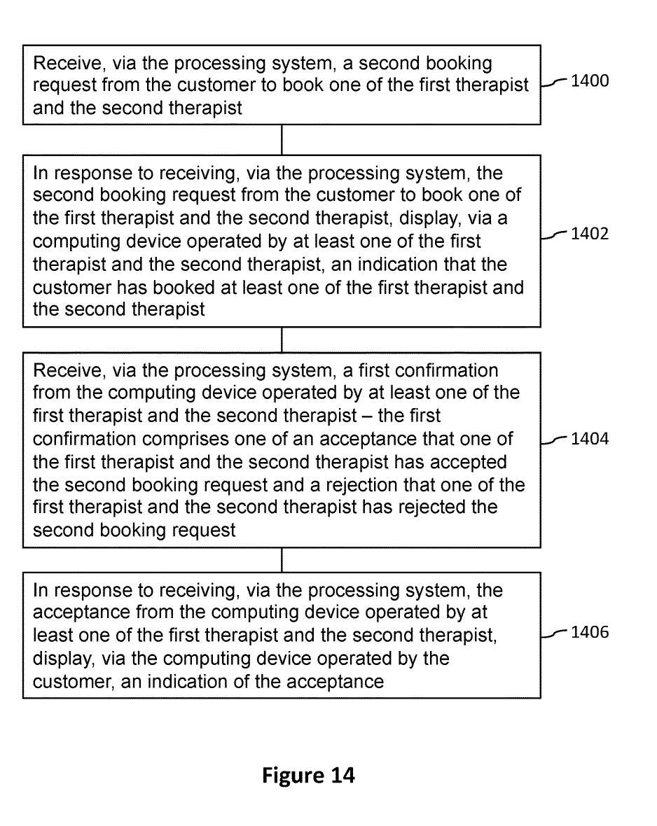

With reference to FIG. 14, the disclosure includes detailed methods for specific scenarios and operations that may be encountered. For example, for customers who have previously used the system and have returned to book another unit of latent inventory, methods can include receiving, via the processing system 12, a second booking request from the customer to book one of the first therapist and the second therapist (at step 1400). In response to the receiving step (1400), methods may include displaying, via a computing device 14 operated by at least one of the first therapist and the second therapist, an indication that the customer has booked at least one of the first therapist and the second therapist (at step 1402). As well, the method may include receiving, via the processing system 12, a first confirmation from the computing device operated by at least one of the first therapist and the second therapist (at step 1404). The first confirmation can include an acceptance that one of the first therapist and the second therapist has accepted the second booking request or a rejection that one of the first therapist and the second therapist has rejected the second booking request.

In response to receiving, via the processing system 12, the acceptance from the computing device 14 operated by at least one of the first therapist and the second therapist, the method can include displaying, via the computing device 14 operated by the customer, an indication of the acceptance (at step 1406). The indication can include a text message, email, audible voice, and/or any indication on the screen of the computing device 14 to show that the therapist has accepted the booking request.

Alternatively, in response to receiving, via the processing system 12, the rejection from the computing device 14 operated by at least one of the first therapist and the second therapist, the method can include displaying, via the computing device 14 operated by the customer, an indication of the rejection (at step 1500). It should be appreciated that the indication of the rejection can include a text message, email, audible voice, and/or any indication on the screen of the computing device 14 to show that the therapist has rejected the booking request.

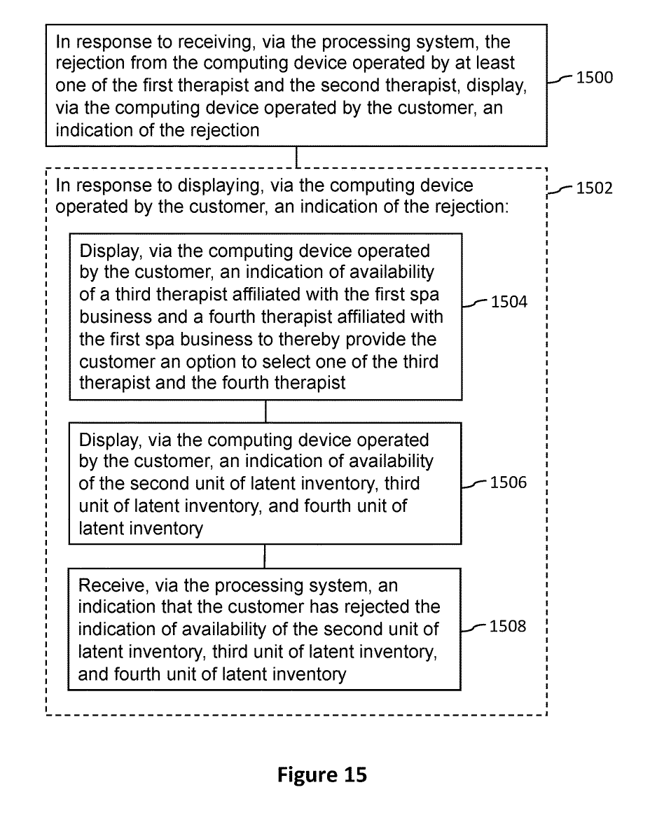

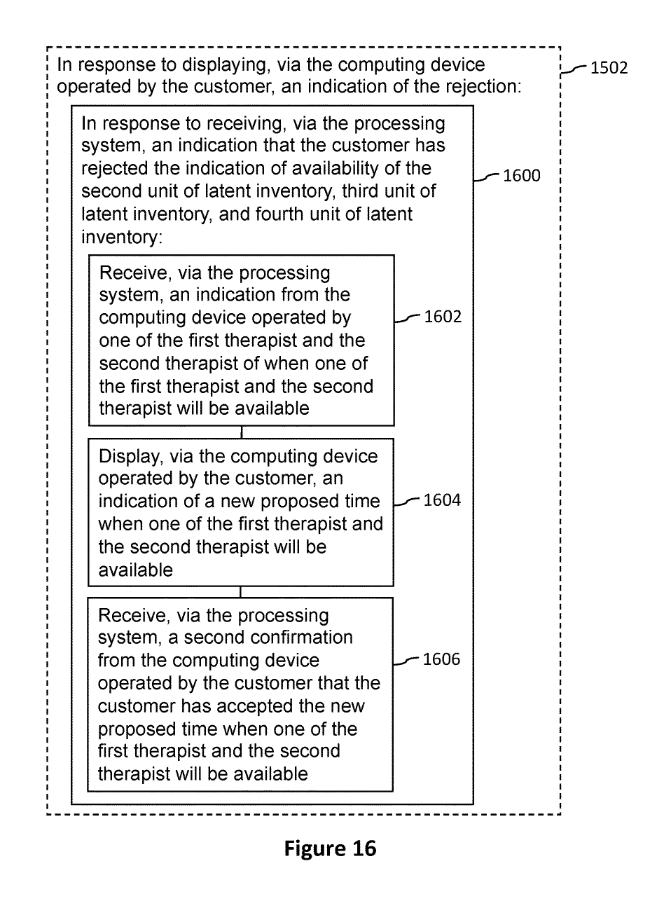

FIG. 15 shows that in response to displaying, via the computing device 14 operated by the customer, an indication of the rejection (at step 1502), the method can perform various steps to locate another unit of latent inventory and thereby book the respective unit of latent inventory for the customer. For example, the method can include displaying, via the computing device 14 operated by the customer, an indication of availability of a third therapist affiliated with the first spa business and a fourth therapist affiliated with the first spa business to thereby provide the customer an option to select the third therapist or the fourth therapist (at step 1504). As well, the method can include displaying, via the computing device 14 operated by the customer, an indication of availability of the second unit of latent inventory, third unit of latent inventory, and fourth unit of latent inventory (at step 1506). The second unit, third unit, and fourth unit of latent inventories can represent various times throughout the day that the third and/or fourth therapist is available. Even still, in response to displaying, via the computing device 14 operated by the customer, the indication of the rejection, the method can include receiving, via the processing system 12, an indication that the customer has rejected the indication of availability of the second unit of latent inventory, third unit of latent inventory, and fourth unit of latent inventory (at step 1508). To further illustrate, the customer may not be available or may not wish to receive therapy at the other available times (e.g. second, third, and fourth units of latent inventory), so the customer may thereby reject the other available times.

Methods may include steps that occur that in response to the occurrence of multiple other steps. FIG. 16 shows that in response to displaying, via the computing device 14 operated by the customer, an indication of the rejection, and in response to receiving, via the processing system 12, an indication that the customer has rejected the indication of availability of the second unit of latent inventory, third unit of latent inventory, and fourth unit of latent inventory (at step 1600), methods may thereby include: receiving, via the processing system 12, an indication from the computing device 14 operated by one of the first therapist and the second therapist of when one of the first therapist and the second therapist will be available later that day (at step 1602). Accordingly, methods may also include displaying, via the computing device 14 operated by the customer, an indication of a new proposed time when one of the first therapist and the second therapist will be available (at step 1604). As well, methods can include receiving, via the processing system 12, a second confirmation from the computing device 14 operated by the customer that the customer has accepted the new proposed time when one of the first therapist and the second therapist will be available (at step 1606). As such, methods may include logic to navigate and adapt to the various circumstances, which may arise during the booking process.

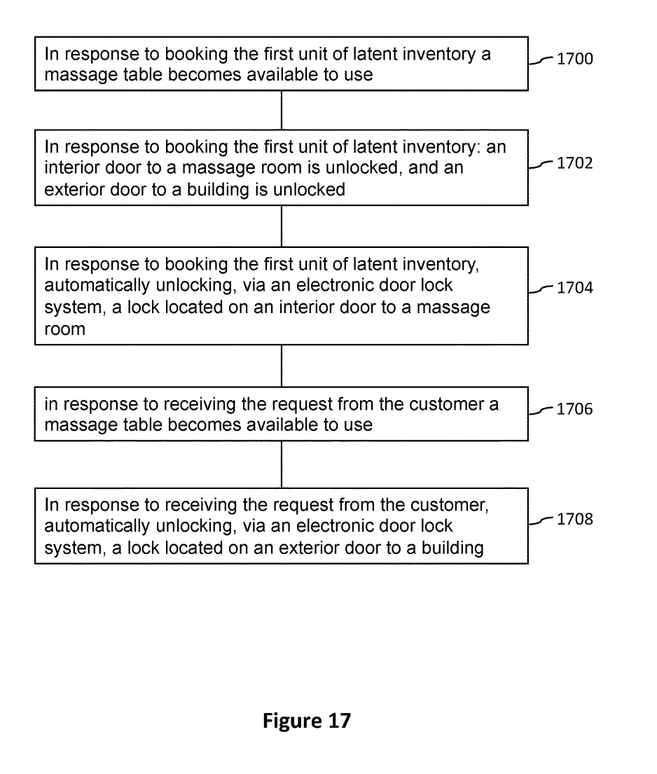

As illustrated in FIG. 17, in response to booking the first unit of latent inventory a massage table 26 can become available to use (at step 1700). Furthermore, in response to booking the first unit of latent inventory: an interior door to a massage room can become unlocked, and an exterior door to a building can become unlocked (at step 1702). In response to booking the first unit of latent inventory, methods may include automatically unlocking, via the door lock system 28, a lock located on an interior door to a massage room (at step 1704). Additionally, in response to receiving the request from the customer a massage table 26 becomes available to use (at step 1706). As well, in response to receiving the request from the customer, methods may include automatically unlocking, via the door lock system 28, a lock located on an exterior door to a building (at step 1708).

### Interpretation

It should be appreciated that a massage table is used by massage therapists to position the client to receive a massage. Massage tables are commonly manufactured with client comfort and therapist ergonomics in mind. Massage tables oftentimes have an easily cleaned, heavily padded surface, and a face cradle that allows the client to breathe easily while lying face down. Furthermore, massage tables may be either stationary or portable, depending on the intended use. Additional padding or supports may be used as accessories to the basic massage table.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A method for booking latent inventory of a spa business, the method comprising:
determining, via a processing system, that a first unit of latent inventory is available at a first spa business;
receiving, via the processing system, a first booking request from a computing device operated by a customer to book the first unit of latent inventory;
booking, via the processing system, the first unit of latent inventory with the first spa business, wherein the determining step is performed on a calendar day, and wherein the first unit of latent inventory is available on the calendar day; and
in response to booking the first unit of latent inventory:
determining, via the processing system, a location of a computing device operated by the first spa business, a location of the computing device operated by the customer, and a meeting location indicating a location of where the first spa business will meet the customer to provide therapy; and
displaying, via at least one of the computing device operated by the customer and the computing device operated by the first spa business, the location of the computing device operated by the first spa business, the location of the computing device operated by the customer, and the meeting location,
wherein in response to booking the first unit of latent inventory a massage table becomes available to use.

2. The method of claim 1, wherein in response to booking the first unit of latent inventory:
an interior door to a massage room is unlocked, wherein the massage table is located in the massage room; and
an exterior door to a building is unlocked, wherein the massage room is located in the building.

2. The method of claim 2, further comprising displaying, via a computing device operated by the customer, an indication of availability of the first unit of latent inventory at the first spa business.

4. The method of claim 3, further comprising receiving, via the processing system, a first confirmation from the first spa business that the first unit of latent inventory has been booked for the customer.

5. The method of claim 3, further comprising determining, via the processing system, that a second unit of latent inventory is available at a second spa business, wherein the second unit of latent inventory is available on the calendar day.

6. The method of claim 5, further comprising:
determining, via the processing system, that a third unit of latent inventory is available at the first spa business, wherein the third unit of latent inventory is available on the calendar day;
determining, via the processing system, that a fourth unit of latent inventory is available at the second spa business, wherein the fourth unit of latent inventory is available on the calendar day;
displaying, via the computing device operated by the customer, an indication of availability of at least two of the first unit of latent inventory, second unit of latent inventory, third unit of latent inventory, and fourth unit of latent inventory; and
displaying, via the computing device operated by the customer, a profile of at least one of the first spa business and the second spa business.

7. The method of claim 6, further comprising:
in response to receiving, via the processing system, the first booking request from the customer to book the first unit of latent inventory, displaying, via the computing device operated by the customer, an indication of availability of a first therapist affiliated with the first spa business and a second therapist affiliated with the first spa business to thereby provide the customer an option to select one of the first therapist and the second therapist;
receiving, via the processing system, a second booking request from the customer to book one of the first therapist and the second therapist;
in response to receiving, via the processing system, the second booking request from the customer to book one of the first therapist and the second therapist, displaying, via a computing device operated by at least one of the first therapist and the second therapist, an indication that the customer has booked at least one of the first therapist and the second therapist;
receiving, via the processing system, a first confirmation from the computing device operated by at least one of the first therapist and the second therapist, wherein the first confirmation comprises one of an acceptance that one of the first therapist and the second therapist has accepted the second booking request and a rejection that one of the first therapist and the second therapist has rejected the second booking request;
in response to receiving, via the processing system, the acceptance from the computing device operated by at least one of the first therapist and the second therapist, displaying, via the computing device operated by the customer, an indication of the acceptance;
in response to receiving, via the processing system, the rejection from the computing device operated by at least one of the first therapist and the second therapist, displaying, via the computing device operated by the customer, an indication of the rejection;
in response to displaying, via the computing device operated by the customer, an indication of the rejection:
displaying, via the computing device operated by the customer, an indication of availability of a third therapist affiliated with the first spa business and a fourth therapist affiliated with the first spa business to thereby provide the customer an option to select one of the third therapist and the fourth therapist;
displaying, via the computing device operated by the customer, an indication of availability of the second unit of latent inventory, third unit of latent inventory, and fourth unit of latent inventory;
receiving, via the processing system, an indication that the customer has rejected the indication of availability of the second unit of latent inventory, third unit of latent inventory, and fourth unit of latent inventory;
in response to receiving, via the processing system, an indication that the customer has rejected the indication of availability of the second unit of latent inventory, third unit of latent inventory, and fourth unit of latent inventory:
receiving, via the processing system, an indication from the computing device operated by one of the first therapist and the second therapist of when one of the first therapist and the second therapist will be available;
displaying, via the computing device operated by the customer, an indication of a new proposed time when one of the first therapist and the second therapist will be available; and
receiving, via the processing system, a second confirmation from the computing device operated by the customer that the customer has accepted the new proposed time when one of the first therapist and the second therapist will be available.

8. The method of claim 3, wherein the first spa business comprises one of a retail spa business, a massage therapist affiliated with the retail spa business, and a massage therapist unaffiliated with the retail spa business, the method further comprising determining, via the processing system, a location of the computing device operated by the customer, wherein the first spa business is determined based upon the location of the computing device operated by the customer, wherein the first spa business comprises one of the massage therapist affiliated with the retail spa business and the massage therapist unaffiliated with the retail spa business, the method further comprising:
determining, via the processing system, a location of a computing device operated by the first spa business;
displaying, via the computing device operated by the customer, the location of the computing device operated by the first spa business; and
displaying, via the computing device operated by the customer, an indication that the first spa business will arrive at a location within a time frame, wherein the location comprises at least one of a site where the customer is located and a site of a retail spa business.

9. The method of claim 3, further comprising at least one of:
receiving, via the processing system, a first rating of the first spa business from the computing device operated by the customer; and
receiving, via the processing system, an indication of a favorite spa business from the computing device operated by the customer.

10. The method of claim 2, further comprising determining, via the processing system, a rating of the first spa business from a third party database, wherein the third party database comprises at least one of a website and a mobile application.

11. The method of claim 2, further comprising receiving, via the processing system, an indication of payment from the customer for booking at least one of the first unit of latent inventory, at least a portion of a membership premium with a company affiliated with the processing system, a monetary tip for a therapist, and a product.

12. The method of claim 2, wherein the first unit of latent inventory is available within five hours of the determining step being performed.

13. A method for booking latent inventory of a spa business, the method comprising:
receiving, via a computing device operated by the spa business, a request from a customer to book a first unit of latent inventory of the spa business;
booking, via the computing device operated by the spa business, the first unit of latent inventory of the spa business; and
sending, via the computing device operated by the spa business, a confirmation of the booking of the first unit of latent inventory to a third party processing system, wherein the receiving step is performed on a calendar day, wherein the first unit of latent inventory is available on the calendar day, and
wherein in response to booking the first unit of latent inventory a massage table becomes available to use.

14. The method of claim 13, wherein in response to booking the first unit of latent inventory, the method further comprising automatically unlocking, via an electronic door lock system, a lock located on an interior door to a massage room, wherein the massage table is located in the massage room.

15. The method of claim 14, further comprising opting in, via the computing device operated by the spa business, to a third party application for booking latent inventory of the spa business.

16. The method of claim 15, further comprising displaying, via a computing device operated by a therapist affiliated with the spa business, an indication that the customer has booked the first unit of latent inventory of the spa business.

17. A method for booking inventory with a massage therapist, the method comprising:
receiving, via a computing device operated by the therapist, a request from a customer to book a first unit of latent inventory of the therapist; and
sending, via the computing device operated by the therapist, a confirmation that the first unit of latent inventory of the therapist has been booked, wherein the receiving step is performed on a calendar day, wherein the first unit of latent inventory is available on the calendar day, and
wherein in response to receiving the request from the customer a massage table becomes available to use.

18. The method of claim 17, wherein in response to receiving the request from the customer, the method further comprising automatically unlocking, via an electronic door lock system, a lock located on an exterior door to a building, wherein the massage table is located in the building.

19. The method of claim 18, further comprising:
determining, via the computing device operated by the therapist, that a second unit of latent inventory of a spa business is available, wherein the second unit of latent inventory of the spa business comprises an amount of time that a vacant room is available at the spa business; and
booking, via the computing device operated by the therapist, the second unit of latent inventory of the spa business.

20. The method of claim 18, wherein the first unit of latent inventory is available within thirty minutes of the determining step being performed, and wherein the receiving step is performed in response to the therapist being located within a predetermined distance of the customer, wherein the therapist is a first therapist, and wherein the receiving step is further performed in response to:
the customer having previously booked a unit of latent inventory with the first therapist at a time before the calendar day,
the first therapist being located closer to the customer than a second therapist,
the first therapist selecting, via the computing device operated by the therapist, a status as available,
the first therapist having a performance rating greater than a predetermined performance rating threshold, and
the first unit of latent inventory of the first therapist being available before a second unit of latent inventory of the second therapist.
